(19) United States
(12) Patent Application Publication
(10) Pub. No.: US 2008/0151885 A1
(43) Pub. Date: Jun. 26, 2008

(54) On-Demand Multi-Channel Streaming Session Over Packet-Switched Networks

(76) Inventors: Uwe Horn, Aachen (DE); Thorsten Lohmar, Aachen (DE)

Correspondence Address: ERICSSON INC., 6300 LEGACY DRIVE, M/S EVR 1-C-11, PLANO, TX, 75024, US

(21) Appl. No.: 11/815,691

(22) PCT Filed: Feb. 8, 2005
(86) PCT No.: PCT/EP05/50544

§ 371 Date: Sep. 27, 2007

(51) Int. Cl. H04L 12/56

(52) U.S. Cl. 370/389

(57) ABSTRACT

An aggregation procedure for aggregating of a number of session descriptions parameters corresponding to a multitude of channels into one single session description. Each channel is described by a mandatory unique identifier. A corresponding client application processes the SDP describing the channel bundle and uses the found information for allowing a user to switch to a channel associated with a certain identifier. Signaling of a channel switch control unit, which is part of the multi-channel streaming server, receives a multitude of RTP flows and selects one of the flows for forwarding to the client. A switching point determination is a part of the channel switch control unit and determines the next possible point of time for switching to a requested channel. The client application receives time information for the switch point in response to a channel switch request.

### TECHNICAL FIELD OF THE INVENTION

The present invention provides a solution for performance to improvement of a multi-channel real-time streaming service in a packet-switched communication system.

Especially the present application is applicable to TV services in a wireless packet-switched telecommunication network. Nevertheless the same principle is applicable to any kind of multi-channel service, which delivers a multitude of content channels among which end-users can select one channel that should be displayed on the screen. Apart from a Mobile TV service, this is for instance the case by selecting between different live cameras as offered within the “Mobile BigBrother” service currently provided by Three-Italy.

### BACKGROUND

Universal Mobile Telecommunication System UMTS is being developed to offer wireless wideband multimedia service using Internet protocol. The UMTS as a third-generation 3G mobile communication combines streaming with a range of unique services. Images, voice, audio and video content are example of multimedia services, which are delivered to the users via media streaming and download techniques, meaning that once the content has been put onto a media server, it can be delivered on-demand via download or streaming. To download content, the user clicks on a link and waits for the content to be downloaded and playback to begin. To access streaming data, the user clicks on a link to start playback, which is almost immediate. This kind of on-demand service is called personalized on-demand streaming, because the user has influence on the choice of the content. Due to the fact that streaming is a semi-real time service that receives and plays back data at the same time, it puts greater demands on protocols and service implementation, especially when the service is to work over networks with little or no quality of service, like this is the case in UMTS. Furthermore the radio resources, which are used on the last part of a transmission is to be used in an efficient way.

The streaming service in a packet-switched network might be provided both to a single user by means of the so-called unicast connections and to a group of users by means of the so-called point-to-multipoint or even multipoint-to-multipoint communication. The point-to-multipoint services pose high demands on the network infrastructure and may consume considerable amounts of bandwidth. Some examples of such services are video-conferencing, whiteboarding, real-time multi-user games, multimedia messaging, virtual worlds or TV-broadcast. This kind of point-to-multipoint applications use broadcast or multicast mode for transmission. Broadcast has the possibility of addressing a packet to all destinations like to every user on the network. By means of the multicast, the content is delivered to a group of users being registered to the multicast group. However the current network evolution does not provide yet a possibility for utilisation of a streaming service on the broadcast transport technique.

Just recently, a new type of on-demand streaming service has been launched in wireless packet-switched networks, namely the so-called mobile TV services, which allows users to watch TV on their mobile phone, based on the same streaming technology, employed for personalized on-demand streaming.

However, on-demand streaming and TV streaming differ in certain usability aspects. In an on-demand streaming service, a user browses for the content until certain content is found. Subsequently, a streaming session is established during which the content of the stream, which is stored at a media server, is delivered to the users' terminal. After the stream has ended, the streaming session is terminated, and the user browses to the next content.

In a mobile TV service, the content is typically not pre-stored at a media server. Instead, it is encoded live from the signal provided by a TV channel.

Nowadays, Mobile TV services are implemented based on existing streaming technology. This means, each channel is accessed via a separate streaming sessions. However existing streaming technology does not support fast switching between channels as needed in a Mobile TV solution. Instead, switching to another channel requires to first close the session delivering the current channel, then going back to a WAP or Web page for selecting a new channel, and last but not least establishing a new streaming session. After the session is established, the client buffers data over a certain period of time (in the order of 5 seconds) before playout starts.

Tearing down the current streaming session followed by setting up a new streaming session in combination with the initial buffering delay after the new session is established results in delays around 20 to 30 seconds for switching between channels. This is clearly far too high compared with the expectations that users have from their TV experience at home.

Therefore the problem is basically that there is no flexible mechanism within the network to let users switch between channels of an ongoing on-demand streaming session. Currently, switching between channels providing the content of the on-demand service requires that an ongoing session is first closed and a new session for the new channel is set-up. Closing one streaming session and setting up a new one introduces a delay of several seconds. After the new streaming session is established, the client buffers incoming packets over certain period of time until playback starts.

### SUMMARY AND DESCRIPTION OF THE INVENTION

It is an object of the present invention to provide a solution for providing a time-efficient on-demand multi-channel streaming service within a telecommunication network. In particular it is object of the present invention to reduce delays in channel switching during an ongoing on-demand streaming session.

The invention is embodied in a method as disclosed in claims 1, 10, 15, 16 and 17. Advantageous embodiments are described in the dependent claims.

The basic idea of this invention is to avoid separate streaming sessions for accessing different channels belonging to the same service. This is achieved by establishing only one streaming session in the beginning over which only those RTP packets are forwarded to the end-user, which belong to the selected channel.

The present invention is claimed in claim 1 describing a method, which is to be described at the server side. In claim 10 a method claiming steps to be performed at the user node are described. In claim 15 the server with its units is claimed and in claim 16 the units of the user node.

The method described in this invention has the advantage of achieving a considerable less delay in switching between channels offered via packet-switched streaming compared to state-of-the-art solutions. Furthermore the invention might be integrated with a minimum impact in the existing protocols, like the Session Description Protocol SDP, in the existing network nodes. It also has only minimal impact on existing streaming client implementation, since channel switching is done in a way, which is transparent to the client.

In the following a detailed description of the invention is given.

In the following preferred examples of the present invention shall be described in detail, in order to provide the skilled person with thorough and complete understanding of the invention, but these detailed embodiments only serve as examples of the invention and are not intended to be limiting. The following description shall make reference to the enclosed drawings, in which

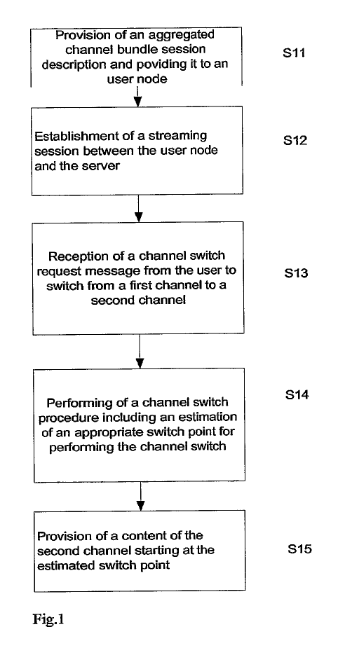

FIG. 1 shows a flowchart of an embodiment of the present invention for performing a channel switch during an ongoing on-demand streaming session at the server side,

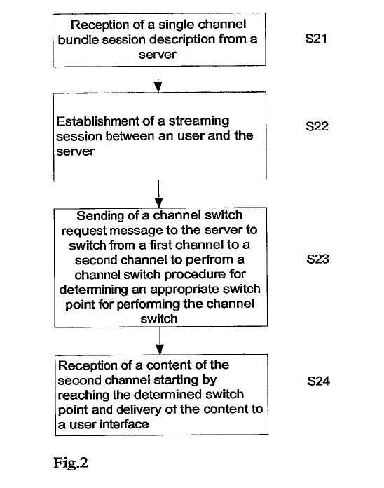

FIG. 2 shows a flowchart of an embodiment of the present invention for performing a channel switch during an ongoing on-demand streaming session at the user node side,

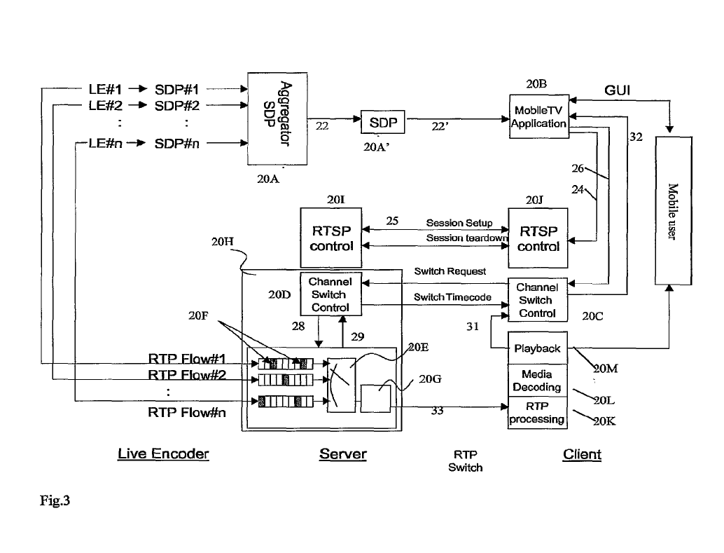

FIG. 3 shows a schematic representation of a system with nodes and interfaces according to an embodiment of the present invention.

It should be noted that the terms “user”, “server”, “client” or generally “node” in the context of the present invention refers to any suitable combination of hardware and software for providing a predetermined functionality in the communication network. In this way, said terms generally refers to a logical entity that can be spread out over several physical nodes of the network, but can also refer to a physical entity located in one physical node. It is to be noted that the terms “client” and “user” are used as synonyms.

Furthermore it should be noted that the term packet-switched on-demand streaming refers to any kind of service, which provides a multitude of content channels. A preferred embodiment is a TV like service.

Preferably, the communication network is a mobile communication network, e.g. is a mobile communication network operating according to GPRS (General Packet Switched Radio) or UMTS (Universal Mobile Telephone System) or GSM. However, the present invention is also applicable in any communication network with the ability to deliver streaming services. In the following an embodiment relating to a mobile network is disclosed. However, it should not be seen as a restriction. Further example is any IP-based communication network.

In the following the steps that are to be performed at the server side are presented in respect to FIG. 1. FIG. 1 is a flowchart of an embodiment of the present invention for performing a channel switch during an ongoing on-demand streaming session at the server side. In step S11 an aggregated channel bundle session description is provided for the user. Said aggregated channel bundle session description includes unique identification of the channels being part of said bundle. The aggregated channel bundle session description is sent to the user in order to inform the user about the on-demand streaming session with a number of channels. In case the user is interested in receiving said session, a streaming session between the user node and the server is established using the aggregated channel bundle session description as an identifier for the session, step S12. In case the user wishes to switch between the available channels, then a corresponding message, namely a channel switch request message is sent from the user node requesting the switch from a first channel to a second channel, S13. Subsequently a channel switch procedure is performed. Within the switch procedure an appropriate switch point for performing the channel switch is determined, S14. It is important to choose the appropriate switch point in order to avoid unnecessary distortion of picture quality, as it will be described in the subsequent part of the description in more details. With step S15 media data of the second channel is provided to the user, wherein the start point of the provision is determined by the determined switch point, S15.

Corresponding steps are to be also performed at the user side. These steps are described in the following in respect to FIG. 2. The user node receives the single channel bundle session description being established from the server, S21. With the receipt of the single channel bundle session description he has the information about the available channels being described by said session description. In case he wishes to receive the content of one of these channels, a streaming session between the user node and the server is be established, S22. In order to switch between channels being part of the bundle, a channel switch request message is sent to the server to switch from a first channel to a second channel, S23. With reception of this message the channel switch procedure for estimating an appropriate switch point for performing the channel switch as described above is initiated at the server. After execution of the channel switch procedure at the server, the user is able to receive content of the second channel starting at the determined switch point, S24. The received content in form of media packets are subsequently decoded and delivered to the user interface where they are played back.

In the following a preferred embodiment of the present invention is described in respect to FIG. 3. The boxes in FIG. 3 represent a nodes being involved in the provision of a Mobile TV over a streaming transmission technology. The arrows between the nodes indicate the communication steps being performed between the nodes.

First, some of the used terms and function being relevant for the explanation of the preferred embodiment are described in some details.

The streaming data is distributed by means of streaming protocols, in particular by means of Real-time Transport Protocol RTP. RTP provides end-to-end network transport functions suitable for applications transmitting real-time multimedia data, such as audio and video over multicast or unicast network services. The functions provided by RTP include payload type identification, sequence numbering, timestamping, and delivery monitoring. The RTP contains a related RTP Control Protocol RTCP augmenting the data transport, which is used to monitor the QoS and to convey information about the participants in an ongoing session. Each media stream in a conference is transmitted as a separate RTP session with a separate RTCP stream.

The Real Time Streaming Protocol RTSP provides session control for streaming sessions and is responsible for establishment of a streaming connection. In particular RTSP establishes and controls either a single or several time-synchronized streams of continuous media such as video and audio. In other words RTSP acts as a “network remote control” for a multimedia server. RTSP is not connected to any transport protocol. That means that as well TCP as UDP might be used for the transport purpose. Furthermore the streams controlled by RTSP may use RTP for the transport purpose of the streaming data. A complete RTSP session, like for example viewing a movie consist of a client setting up a transport mechanism, for example by means of RTSP SETUP message, starting the stream with PLAY and closing the session with TEARDOWN. In respect to FIG. 3 these steps are described by means of the connection 24 and 25. The detailed description of RTSP might be found in RFC 2326 “Real Time Streaming Protocol” by H. Schulzrinne, A. Rao, R. Lanphier, April 1998.

The set of streams to be controlled by RTSP is described by a presentation description, like or example by a Session Description Protocol SDP as specified in RFC 2327 “SDP: Session Description Protocol” by M. Handley, V. Jacobson, April 1998. SDP describes multimedia sessions for the purpose of session announcement or session invitation in order to allow the recipients of a session description to participate in the session. Actually the SDP is purely a format for session description. It does not incorporate a transport protocol therefore is intended to use different transport protocols like for example RTSP. SDP session descriptions are entirely textual consisting of a number of text of the form <type>=<value>, describing for instance the used codecs and bitrates. In the following some lines of a SDP description are given, wherein the optional items are marked with a “*”.
v=(protocol version)
o=(owner/creator and session identifier).
s=(session name)
i=* (session information)
u=* (URI of description)
e=* (email address)
p=* (phone number)
c=* (connection information)
b=* (bandwidth information)
z=* (time zone adjustments)
k=* (encryption key)
a=* (zero or more session attribute lines)
t=(time the session is active)
r=* (zero or more repeat times)
m=(media name and transport address)
i=* (media title)
c=* (connection information
b=* (bandwidth information)
k=* (encryption key)
a=* (zero or more media attribute lines)

In a preferred implementation the description of the channel bundle is put into a specially formatted string following the “s=” line in SDP. As an alternative it could also be put into a separate configuration element (e.g. XML)

Returning to FIG. 2, there is a SDP aggregator, 20A providing a channel bundle description SDP, 20A′, which is processed by a multi-channel streaming client (e.g. Mobile TV application), 20B. The top left of FIG. 3 shows the Live Encoders LE#1 to LE#n. Each live encoder takes as input an analog video/audio signal, which is converted first into a digital signal and then compressed by a media encoder. The resulting bitstream is then packetized and delivered as a stream of RTP packets, RTP flow#1 . . . RTP flow#n to a streaming server, server, to which end-user, client, can connect. The streaming server has a channel switch control unit 20H, which will be described in more details further. In the channel switch control unit there is a channel switch control 20D, which communicates with an adequate channel switch control on the user's side, 20C. There is also a RTSP control, 20I on the server side communicating with the RTSP control, 20J on the user side. The streaming data from the server is transported over Single “Mobile TV” RTP Flow, 33 to a RTP processing, 20K being part of a unit consisting also of Media Decoding, 20L and a Playback function, 20M, forwarding, 34 the data the user's device, 20N.

In the following the inter-processing of the nodes and their functionality is described in respect to FIG. 3.

As already mentioned each live encoder takes as input an analog video/audio signal, which it compresses. LE#1 . . . LE#n. The resulting bitstream is then packetized and delivered as an RTP flow to the server. Each live encoder also produces an SDP file, SDP#1 . . . SDP#n, which contains a description of the stream generated by the live encoder. An example of a typical SDP is the following:
v=0
o=Live Encoder 16843009 1 IN IP4 127.0.0.1
s=Channel One
c=IN IP4 192.168.16.254
t=0 0
b=AS:128
a=control:*
a=range:npt=0-
m=video 6950 RTP/AVP 96
b=AS:128
a=rtpmap:96 MP4V-ES/90000
a=control:trackID=1
a=range:npt=0-
a=fmtp:96 profile-level-
id=8;config=0000010B008000001B5090000010000 0001200084400668282078A21F

Herein the line starting with “s=” contains a string describing the stream, in this case it is “Channel One”. A streaming client usually puts this information into a title bar above or below the video window.

The aim of the SDP aggregator, 20A is it to generate from a number of the SDPs, SDP#1 . . . SDP#n of the Live Encoders LE#1 . . . LE#n a single SDP, 20A′. This SDP contains all information needed by the client and the server for controlling the service. By comparing the appropriate attribute lines in the various SDP files, the SDP aggregator verifies that within a channel bundle all channels are encoded at the same bitrate with the same codecs. The SDP aggregator then generates one single SDP, which describes the complete channel bundle.

In a preferred embodiment, the new SDP, 20A′, describing the complete channel bundle looks like a standard SDP. All information about the aggregated channels is contained in the “s=” attribute line.

The idea is to use a specially formatted string, which can be interpreted by a Software running on the client. The string contains per channel a unique identifier by which the channel can be referenced together with the human readable channel identifier taken from the SDP produced by the Live Encoder. For example assuming that there are two channels “Channel One” and “Channel Two”. “Channel One” is described by the aforementioned SDP description. “Channel Two” is described by the following SDP:
v=0
o=Live Encoder 16843009 1 IN IP4 127.0.0.1
s=Channel Two
c=IN IP4 192.168.16.254
t=0 0
b=AS:128
a=control:*
a=range:npt=0-
m=video 6952 RTP/AVP 96
b=AS:128
a=rtpmap:96 MP4v-ES/90000
a=control:trackID=1
a=range:npt=0-
a=fmtp:96 profile-level-
id=8;config=000001B008000001B5090000010000 0001200084400668282078A21F

Thus, the only difference in the two SDPs description is in the “s=” and in the “m=” line. The “s=” contains “Channel Two” instead of “Channel One” as channel identifier, the “m=” line contains 6952 instead of 6950 as the RTP port number over which the RTP packets are delivered. Note that the live encoders have to be configured such that not two of them are using the same port number.

As already mentioned the task of the SDP aggregator is to merge the two SDPs into a new one, which looks like the following:
v=0
o=Live Encoder 16843009 1 IN IP4 127.0.0.1
s=1:Channel One; 2:Channel Two
c=IN IP4 192.168.16.254
t=0 0
b=AS:128
a=control:rtsp://mobiletv.com/Bundle-1
a=range:npt=0-
m=video 0 RTP/AVP 96
b=AS:128
a=rtpmap:96 MP4V-ES/90000
a=control:rtsp://mobiletv.com/Bundle-1:trackID-1
a=range:npt=0-
a=fmtp:96 profile-level-
id=8;config=000001B008000001B5090000010000 0001200084400668282078A21F

Herein the “s=” line contains the string “1:RAI Uno; 2:RAI Due” and the “m=” line contains 0 as a new port number. This indicates that the port number is negotiated when the RTSP session is established. The configuration string tells the client that this bundle contains two channels, “Channel One” and “Channel Two”, referenced by the unique identifier “1” and “2”, respectively. In addition an “a=” line with a fully specified RTSP control URL was added.

Returning to FIG. 3 the SDP describing the channel bundle can be delivered to the client in various ways. The client could for instance download the SDP from a Web server using a URL http-address, like for example http://mobiletv.com/Bundle-1sdp.

As an alternative, the client first receives the RTSP URL, like for example rtsp://mobiletv.com/Bundle-1 in the above mentioned example, and the SDP is then delivered to the client during the RTSP session setup. In respect to FIG. 3 this is done on the connection 22′ by forwarding the description string to the Mobile TV application, 20B. The Mobile TV application parses the string and generates from it a list of available channels.

The list of available channels can be displayed upon user request in a channel selection menu. The entries of this list are also used to display a channel identifier in a title bar above or below the video window.

The user also has the possibility to map entries of this list to particular keys on the phone. In this way, the mobile phone keyboard can be used and programmed like a remote control.

For the purpose of the establishment of a RTSP session the client uses the RTSP URL from the SDP file or the RTSP URL, which it finds on a web page to setup the streaming session. This corresponds to switching on the Mobile TV receiver, 24,25.

It is proposed that by default, the server starts to deliver the channel corresponding to the first entry in the channel bundle description string delivered within the SDP described above. Alternatively, the server starts to deliver the channel to the user, which was delivered as the last one during the last session.

If the user triggers a switch to a new channel, the mobile TV application signals the new channel to the channel switch control 20C with the step 26 in respect to FIG. 3.

It is proposed that the channel switch requests, 26 is signaled “in-band” directly to the streaming server via the RTSP streaming session control protocol or “out-band” using e.g. the HTTP protocol. In the latter case, the switch request must contain not only the channel address, which is available to the Mobile TV Application but also a unique identifier of the affected streaming session, such that the streaming server knows, for which session a channel switch should be executed.

In a preferred embodiment the RTSP SET_PARAMTER message, being sent by means of the connection 26, is used for in-band signaling as outlined in the following example:

```
RTSP: SET_PARAMETER
rtsp://mobiletv.com/Bundle-1 RTSP/1.0
        CSeq: 10
        Content-length: 14
        Content-type: text/parameters
        Channel: 2
```

In this example the client sends an RTSP SET_PARAMETER command containing the message “Channel: 2” to the server, telling the server that it should switch to channel “2” (in our example “Channel Two”). The user's request, 27, for switching a channel is forwarded from the Channel Switch Control, 20C, on the user side to the Channel Switch Control, 20D, on the network side, namely on the server.

The channel switch control unit at the server handles the switch request and decides at which point in time RTP packets belonging to the new channel are to be forwarded to the client. This is also the reason for having the channel switch control unit since switching from one channel to another is only possible at certain synchronization points. Synchronization points mark positions, 20F, in the data flow at which decoding of the channel can be started even if no other data for this channel has been received before. For instance, decoding of a video stream can only be started at so-called Intra frames, which are encoded without reference to any previously transmitted pictures. Lowest switching delay is achieved if every frame is encoded as an Intra-frame since then decoding of a video stream can start at every frame. However, Intra-frames require considerably more bits than frames, which are encoded with reference to a previously transmitted frame. Therefore, a video stream should not contain too many Intra-frames. However, to avoid long delays during channel switching there should be at least one Intra-frame every two to five seconds. Another advantage of having frequent Intra-frames is that if a transmission error introduces an error into the received video, this error will vanish after the next Intra-frame. It is to be noted that the Intra-frame interval can be configured at the live encoder.

For the client it is not possible to “guess” at what point in time content from the new channel is on the display. For the client switching between channels is transparent. Therefore, the client has no indication at what point in time content belonging to the new channel is received. One solution would be to use an estimate for the delay between signaling a channel switch until the content of the new channel appears in the client's video window. However, this does not give accurate results since this delay depends on many factors for instance the delay for the signaling itself, processing delays at the server, time until the next synchronization point from which on packets belonging to the new channel are forwarded to the client, amount of client-buffered data belonging to the old channel and so on. Therefore it is hard to predict.

The server has buffers for buffering the RTP flows, RTP Flow#1 . . . RTP Flow#n with their switching points 20F. Said RTP flows are provided to the channel selection unit, 20E, which also receives a request from the channel switch control unit, 20D. The task of the channel selection unit is to synchronize the execution of the switch command with respect to the possible switching points. Thus, when receiving a switch request, the channel selection unit first inspects the queue of RTP packets for that flow which corresponds to the new channel in order to identify the earliest possible switching time. This time is then signaled back, 29, 30, to the client as response to the RTSP SET_PARAMETER request, which has triggered the execution of the channel switch. The client then knows at which point in time the content of the new channel is displayed on the screen and can change the title bar accordingly.

In a preferred implementation the time is signaled in the NPT (normal play time) format commonly used in RTSP.

An example of a response to the switch request shown in the previous subsection is the following, which is sent via the communication 30:

```
S->C: RTSP/1.0 200 OK
    CSeq: 10
    Content-Length: 20
    Content-Type: text/parameters
    Channel: 2
    SwitchPoint: npt=32-
```

With this message the server confirms that it has received the switch request for channel 2 and that display of channel 2 will start at second 32 after the start of the session.

Subsequently the channel selection unit continues to forward packets belonging to the current channel until the playback time has reached the identified switching point. From that point onwards, RTP packets belonging to the new channel are forwarded.

The switch control unit, 20D also takes care of rewriting the RTP header of the outgoing RTP packets, 20G. This is necessary, since the header information of the RTP packets generated by the different live encoders is not synchronized. The RTP headers of different RTP flows carry different SSRCs, different sequence numbers and different RTP playout time. In order to emulate one single RTP flow, the switch control unit at the server synchronizes the RTP flows of the different live encoders to a common playout timeline and sequence number space. This is achieved by rewriting the relevant fields in the RTP.

This is explained in the following example. Let's assume that Live Encoder 1 (LE1) delivers RTP packets with the following headers to the server:
1) <SN=1001 TS=9000 SSRC=12345678> <Payload 1.1>
2) <SN=1002 TS=18000 SSRC=12345678> <Payload 1.2>
3) <SN=1003 TS=27000 SSRC=12345678> <Payload 1.3>
4) <SN=1004 TS=36000 SSRC=12345678> <Payload 1.4>
5) <SN=1005 TS=45000 SSRC=12345678> <Payload 1.5>

Herein the line
1) <SN=1001 TS=9000 SSRC=12345678> <Payload 1.1>
   means that packet 1 carries in its RTP header sequence number SN=1001, time stamp TS=90000, and synchronization source identifier SSRC=12345678 and that it delivers media payload 1.1, which references media payload of the first packet of stream 1.

Let's further assume that Live Encoder 2 (LE2) delivers the following RTP packets:
1) <SN=2011 TS=15000 SSRC=87654321> <Payload 2.1>
2) <SN=2012 TS=24000 SSRC=87654321> <Payload 2.2>
3) <SN=2013 TS=33000 SSRC=87654321> <Payload 2.3>
4) <SN=2014 TS=42000 SSRC=87654321> <Payload 2.4>
5) <SN=2015 TS=51000 SSRC=87654321> <Payload 2.5>

We further assume that a client has requested a switch from stream 1 to stream 2 and that it was determined that the switch to stream 2 shall be executed at packet 3. An example for the flow of RTP packets delivered from the server to the client is the following sequence:
1) <SN=10000 TS=90000 SSRC=7236237<Payload 1.1>
2) <SN=10001 TS=99000 SSRC=7236237> <Payload 1.2>
3) <SN=10002 TS=108000 SSRC=7236237> <Payload 2.3>
4) <SN=10003 TS=117000 SSRC=7236237> <Payload 2.4>
5) <SN=10004 TS=126000 SSRC=7236237> <Payload 2.5>

It can be seen that the RTP header information of the original RTP packets was rewritten such that the resulting RTP stream does not contain any “jumps” neither in sequence numbers SN nor in time stamps TS. Also the SSRC identifier was changed accordingly. However, the payload is copied from stream 1 for the first two packets and from stream 2 starting with packet 3 for all following packets.

The channel switch control unit, 20C at the client is arranged to receive the playout time, 31 of the currently displayed frame from the streaming player. It compares this time with the channel switch time, which was signaled back from the server. If the playout time is larger than the channel switch time, the channel switch control unit generates a trigger for the Mobile TV application, 32, which then changes the channel identifier in the title bar of the video window.

Session teardown (e.g. switching off the mobile TV receiver) is handled like in standard RTSP streaming and therefore it will not be described further.

Although the present invention has been described primarily with respect to method steps, it is noted that the present invention can not only be embodied in the form of a method, but also in the form of a computer program product comprising a computer program that is arranged to perform such a method when executed on a node of a data unit transport network. The computer program product can e.g. be a computer program itself or a computer program carrier that carries the computer program.

Furthermore, the present invention can also be embodied in the form of appropriate nodes such as the server and the user node mentioned in FIG. 1.

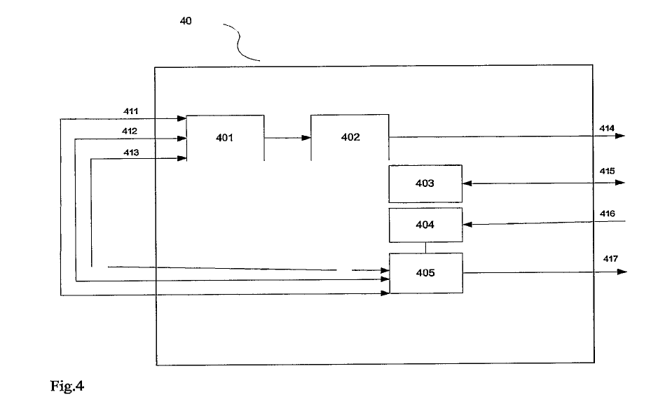

FIG. 4 shows a schematic diagram of a node 40 representing a server device that communicates with a user node via the connections 414 to 417. Node 40 comprises an aggregator 401 adapted to aggregate a bundle of channels 411,412,413, wherein each channel of the channel bundle is described by an unique channel identifier. The aggregator is arranged to generate a single channel bundle session description 402 that is provided to the user node via the connection 414. Furthermore, the server 40 has a session establishment control unit 403 adapted to provide a streaming session 415 between the user node and the server. The establishment of the session the provision of the streaming session is done by means of the channel bundle session description 402. In case a user node decides to switch from a first channel to a second channel being part of the channel bundle session description 402, a corresponding channel switch request message 416 is generated at the user node and provided to the server 40. A channel switch control unit 404 is adapted to receive the channel switch request message 416 from the user node. Furthermore, the channel switch control unit 404 is adapted to control a channel switch from a first channel to a second channel. The performing of the channel switch is assisted by channel selection unit 405 which is adapted to switch between the first and the second channel wherein said channel selection unit is adapted to estimate an appropriate switch point for performing the switch and to provide the content of the second channel 417 to the user node by reaching the determined switch point.

Furthermore, the server 40 preferably also comprises a queue buffer (not explicitly shown in FIG. 40) for queuing received data units over the connections 411 to 413 before forwarding them to the channel selection unit 405.

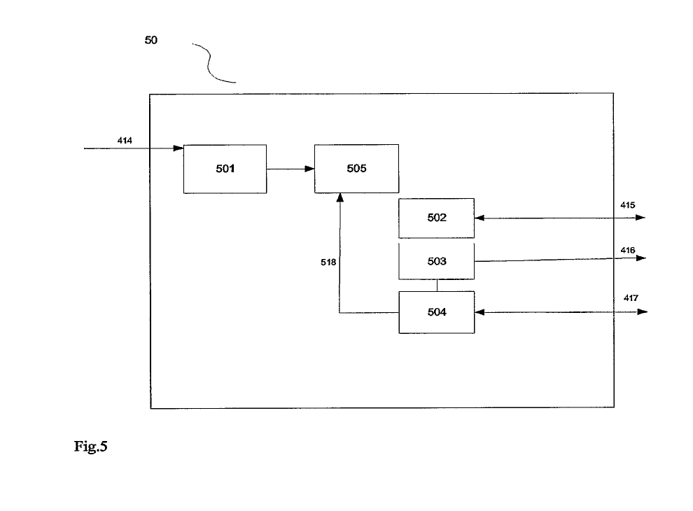

FIG. 5 is a schematic representation of a node 50, representing a user node, which communicates with the server 40 via the connections 414 to 417. Node 50 comprises a streaming application unit 501 adapted to receive a single channel bundle session description via the connection 414 from the server. The single channel bundle session description includes the description of the channels, which might be provided to the user node with the single on-demand streaming session. The user node is adapted to make a choice among the bundle of the channels. Each channel of the channel bundle is described by an unique channel identifier being provided to the user node 50. Furthermore, the user node 50 comprises also a session establishment control unit 502 adapted to establish one streaming session 415 from the user node to the server. The establishment of the session is carried out by means of the channel bundle session description. In case a user decides to switch from a first channel to a second channel then a corresponding message is generated and a channel switch control unit 503 is adapted to send a channel switch request message 416 to the server 40, which is arranged to perform a channel switch from a first channel to a second channel. Furthermore, the user node 50 comprises a content provision unit 504 for receiving the content of the second channel 417 and for delivering said content to a user interface 518.

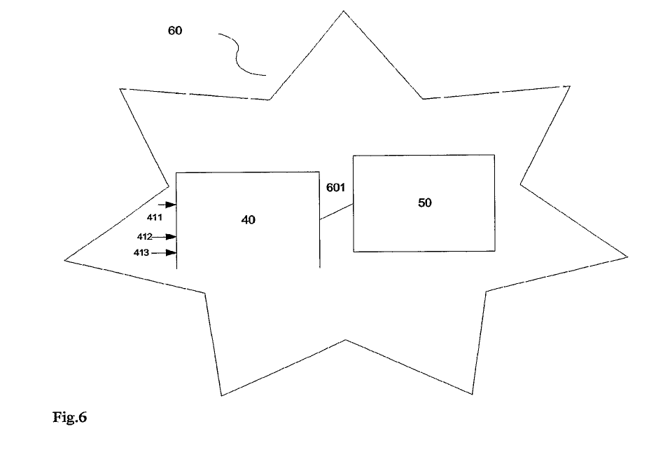

The previously described nodes, 40 and 50 can be provided by any suitable combination of hardware and software. They are also part of a system 60 as it is depicted in FIG. 6. FIG. 6 shows a system with a server 40 receiving channels 411, 412, 413. Said channels are prepared in the node 40 as it is disclosed above in respect to FIG. 1. Node 40 performs methods steps as it is described in respect to FIG. 1. There is also a node 50 as described in respect to FIG. 5 performing the methods steps according to FIG. 2. The nodes 40 and 50 are adapted to communicate with each other via a communication link 601, which is a schematic representation for the exchange of messages 414 to 417 in respect to FIG. 4 and FIG. 5. The messages exchange is also disclosed in the description to FIG. 1, FIG. 2 and FIG. 3.

The present application is applicable for a TV like service in a wireless packet-switched telecommunication network. Nevertheless the same principle is applicable to any kind of service, which delivers a multitude of content channels among which end-users can select. Apart from a Mobile TV service, this is for instance the case by selecting between different live camera signals.

1. A method for providing an on-demand streaming session to a user node of a packet-switched communication network wherein said on-demand session is available at a server said session comprising a number of channels providing a content and being accessible by the user node, the method comprising the following steps performed at the server:
providing an aggregated channel bundle session description to the user node wherein each channel of the channel bundle is described by means of a unique channel identifier;
establishing one streaming session between the user node and the server using the aggregated channel bundle session description
receiving a channel switch request message from the user node to perform a channel switch from a first channel to a second channel wherein the channels are identified by means of the unique channel identifier
performing a channel switch procedure for switching between the first and the second channel within the established streaming session wherein the switching comprises determination of an appropriate switch point for performing the switch; and
providing the content of the second channel starting at the determined switch point.

2. The method according to claim 1 wherein the determined switch point is also provided to the user in order to synchronize the channel identifier being displayed in a client application together with the channel content.

3. The method according to claim 1 wherein the single channel bundle session description includes a string being interpretable by software executed on the user node.

4. The method according to claim 1 wherein the provision of the aggregated channel bundle session description includes verification whether the channels of the channel bundle are encoded at the same bit rate with the same codecs.

5. The method according to claim 1 wherein the channels switch request is signaled in-band using a streaming control protocol or out-band using an application protocol.

6. The method according to claim wherein channel switch is performed at synchronization points marking position in a data flow of the content at which decoding of the channel can be started without any quality degradation.

7. The method according to claim 6 wherein a time distance between the synchronization points is to be chosen such that the trade-off between channel switching delay and compression efficiency is optimized.

8. The method according to claim 1 wherein further in the scope of the channel switch procedure, data packets of the channel being provided to the user node are modified at the server by means of modifying the header of the outgoing data packets in order to synchronize said data packets in a way to provide a common playout and sequence number space.

9. A method for providing an on-demand streaming session, to a user node of a packet-switched telecommunication network wherein said on-demand streaming session is provided by a server, said session comprising a number of channels providing the content and being accessible by the user node, the method comprising the following steps performed at the user node:
receiving a single channel bundle session description from the server, wherein each channel of the channel bundle is described by a unique channel identifier;
establishing of one streaming session from the user node to the server using the channel bundle session description;
sending a channel switch request message to the server to perform a channel switch procedure for switching between a first and a second channel within the established streaming session wherein the switching comprises a determination of an appropriate switch point for performing the switch wherein the channels are identified by means of the unique channel identifier;
receiving the content of the second channel by reaching the determined switch point and delivering said content to a user interface.

10. The method according to claim 9 wherein the single channel bundle session description includes a string that is interpretable by a streaming application running on the user node, wherein a list of the available channels is generated and presented to a user.

11. The method according to claim 10 wherein the list of available channels is displayed upon user request in a channel selection menu a channel identifier is displayed in a title bar above or below the video window.

12. The method according to claim 10 wherein the list is mapped to particular keys on a phone in order to use the mobile phone keyboard like a remote control.

13. The method according to claim 9 wherein the determined switch point is also provided to the user in order to synchronize the channel identifier being displayed in a client application together with the channel content.

14. The method according to claim 9 wherein the user node compares the currently displayed frame and the received switch point and in accordance with the result a trigger is sent to the streaming application to change the channel identifier in the title bar of the video window.

15. A server adapted to provide an on-demand streaming session to a user node of a packet-switched wireless telecommunication network wherein said on-demand streaming session is provided by said server said session comprising a number of channels providing a content and being accessible by the user node, the server comprising:
an aggregator adapted to aggregate a bundle of channels, wherein each channel of the channel bundle is described by a unique channel identifier, into a single channel bundle session description said aggregator being adapted to provide said single channel bundle session description to the user node;
a session establishment control unit adapted to provide a streaming session between the user node and the server being identified by the channel bundle session description;
a channel switch control unit adapted to receive a channel switch request message from the user node and to perform a channel switch from a first channel to a second channel within the established streaming session; and
a channel selection unit adapted to switch between the first and the second channel wherein said channel selection unit is adapted to estimate an appropriate switch point for performing the switch and to provide the content of the second channel to the user node by reaching the estimated switch point.

16. A user node of a packet-switched telecommunication network adapted to receive an on-demand streaming session wherein said on-demand streaming session is provided by a server said session comprising a number of channels providing the content and being accessible by the user node, the user node comprising:
a streaming application unit adapted to receive a single channel bundle session description from the server wherein each channel of the channel bundle is described by a unique channel identifier and,
a session establishment control unit adapted to establish one streaming session from the user node to the server by means of the channel bundle session description and,
a channel switch control unit adapted to send a channel switch request message from the user node to the server to perform a channel switch from a first channel to a second channel within the established streaming session wherein the channels are identified by means of the unique channel identifier and,
a content provision unit for receiving the content of the second channel and for delivering said content to a user interface.

17. (canceled)
